(19) United States
(12) Patent Application Publication
(10) Pub. No.: US 2010/0301146 A1
(43) Pub. Date: Dec. 2, 2010

(54) Composition of milling medium and process of use for particle size reduction

(76) Inventor: Yun-Feng Chang, Houston, TX (US)

Correspondence Address: YUNFENG CHANG, 4443 STERLING WOOD WAY, HOUSTON, TX, 77059, US

(21) Appl. No.: 12/454,826

(22) Filed: May 26, 2009

(51) Int. Cl. B02C 23/00; C09K 3/14

(52) U.S. Cl. 241/21; 241/26; 51/307

(57) ABSTRACT

Composition and use of milling medium to prepare a polishing medium to be used in chemical and mechanical polishing applications.

### FIELD OF THE INVENTION

The present invention provides a composition of milling medium and a process using it for particle size reduction.

### BACKGROUND OF THE INVENTION

Particle size reduction is a critical step in achieving high performance in many materials applications, including, (1) chemical and mechanical polishing (or planarization) (CMP), (2) ceramic product fabrication, (3) catalyst preparation, (4) pigment manufacturing, (5) preparation of nano-particles from conventional materials. For CMP application, a desired particle size (i.e., <1 micron) and a desired particle size distribution (PSD) have to be met. This requires precise control of particle size through particle size reduction or milling process. For ceramic product fabrication, control of both particle size and PSD is needed to achieve high mechanical strength of the end-product and low defects and shrinkage after shaping and calcination or sintering. Many catalyst preparations require small and uniform particle size distribution of the active component or components for product shaping, i.e., extrusion, granulation, or spray drying. Typically, a small particle size is needed for better uniformity and overall mechanical strength of the end-product. For pigment applications, particle size, morphology and PSD need to be tailored to achieve a desired color, coverage efficiency, and brightness or glossiness. Despite many direct routes for synthesis of nano-particles, it is both convenient and cost-effective to produce nano-particles through particle size reduction from otherwise conventional particles.

Depending on nature of the starting materials, i.e., particle size, hardness of the particles, concentration of the particles, and the requirement of the end product, a number of particle size reduction or milling techniques or equipment can be chosen from. For materials of high hardness, for fast particle size reduction, it is best to choose a high shear mixer or mill. However, high shear mills normally do not handle high viscosity or high solids content materials well. High shear mills also have limitation on particle size of the starting materials. Typically, they process material with a small particle size difference between the starting materials and the resultant materials. Also, to process high hardness materials, moving parts in contact with the processed materials suffer very significant wearing and tearing.

For materials of high solids and high viscosity and required large particle size reduction, or a wide range of particle size variation between starting material and finishing materials, a different type of mill that offers both flexibility and performance is required.

This invention provides means to design and select milling medium to maximize milling efficiency, and minimize wear and tear of the milling medium.

### DETAILED DESCRIPTION OF THE INVENTION

Medium mills use a combination of high agitation speed and choice of different materials of construction of milling medium and size and shape to achieve desired milling requirement, i.e., milling efficiency and throughput, as well as minimizing potential contamination introduced from wearing and tearing of milling medium. In order to be able to process high solids and high viscosity slurries, medium mills have to rely on a milling medium having high density. However, there are limits on how high the density of milling medium could be with given composition. Therefore, one has to resort to other means to achieve high milling efficiency at the same time to reduce or to eliminate loss rate of milling medium due to wearing and tearing. One recognized practice is selecting highly spherical particles with very even surface finishing. It is further recognized that selecting a milling medium having a significantly higher hardness than the materials to be processed will lower wearing and tearing. It becomes obvious that for processing materials of both high density and high hardness, for example, alpha alumina, there is very little room in operation space and materials selection for a milling medium because of small differences between milling medium and materials to be processed. Consequently, loss rate of milling medium can be quite substantial. This leads to not only high cost of operation due to medium loss but also potential high contamination introduced into the processed materials from abrasion and erosion of the milling medium. We have found that by adjusting surface properties, i.e., surface charge or zeta potential, during milling operation, loss of milling medium can be greatly reduced.

Particle size distribution (PSD) describes the relative proportion of individual particle size. Polishing medium consists of particles ranging from nanometers to a few microns. Particles smaller than one micron are also called colloidal particles. Brownian motion is a characteristics of a colloidal particle and the size range is 1 nm to 100 nm, while others have defined colloidal particles being in the range from 5 nm to 500 nm (see J-E. Otterstedt and D. A. Brandreth, Small Particles Technology, Plenum Press, New York, 1998, p. 8). Particles above 500 nm or 0.5 micron in size settle from water in a matter of days, but if they are less than 70 nm, they do not settle under gravity because of Brownian motion keeps them in suspension.

Particle size or particle size distribution (PSD) are obtained by commonly known techniques like (1) sedigraph, for example, Micromeritics SediGraph 5000E, SediGraph 5100 based on particle sedimentation measured by x-ray, it measures particles in the range of 0.5-250 microns; (2) laser scattering, which measure light scattering by particles, particularly small particles, for example, Horiba LA9100, Microtrac S3500, measuring particles in the range of 10 nm to 3000 microns; (3) acoustic and electro-acoustic techniques, for example, Matec ESA 9800, and Dispersion Technologies DT-1200, measuring particles in the range of 30 nm to 300 microns; (4) ultracentrifugation, in particular, disc centrifuge, for example CPS Instruments DC2400, measuring particles from 5 nm to 75 microns; (5) electroresistance counting method, an example of this is the Coulter counter, which measures the momentary changes in the conductivity of a liquid passing through an orifice that take place when individual non-conducting particles pass through. The particle count is obtained by counting pulses, and the size is dependent on the size of each pulse; (6) high sensitivity electrophoretic laser scattering technique, like Brookhaven Instruments ZetaPals and ZetaPlus, measuring particles of 10 nm to 10 microns; (7) electron microscopic imaging, scanning electron microscopy (SEM) and transmission electron microscopy (TEM); (8) optical microscopy. Particle size analyzed ranging from a few nanometers to a few millimeters. Often time, more than one technique is required to get the full distribution. More comprehensive dealing of particle size measurements using light scattering can reference the book, “Particle Characterization: Light Scattering Method”, by Renliang Xu, Kluwer Academic Publisher, Dordrecht, The Netherlands, 2000. More generic treaty of fine particle characterization can reference monograph “Analytical Methods in Fine Particle Technology”, by P. A. Webb and C. Orr, Micromeritics Instrument Corp., Norcross, Ga. More comprehensive dealing of particle characterization and preparation can reference the book by J-E. Otterstedt and D. A. Brandreth, “Small Particles Technology”, Plenum Press, New York, 1998; and book by A. M. Spasic and J-P. Hsu, “Finely Dispersed Particles: Micro-, Nano-, and Atto-Engineering”, Taylor & Francis, Roca Raton, 2006.

Materials and tools or equipment required for complete CMP process integration is outlined in the book by J. M. Steigerwald, S. P. Murarka, and R. J. Gutmann in “Chemical Mechanical Planarization of Microelectronic Materials”, Chapter 1, John Wiley & Sons, New York, 1997. They include (i) consumables, (ii) distribution management systems, (iii) CMP polishers, (iv) post CMP clean systems, and (v) thin film measurements. The consumables used are (1) oxide slurries, (2) metal slurries, (3) post clean chemicals, (4) polishing pad, and (5) carrier films. Distribution management systems comprise of (1) mixing, (2) distribution, (3) dispersing, and (4) filtration. CMP polishers include (1) single head, (2) multi-head, (3) end-point detection. Post CMP clean systems consist of (1) scrubbers, (2) megasonic, and (3) other clean. Thin film measurements include (1) surface profiling, (2) non-uniformity, (3) surface defects, and (4) other inspecton.

The D_{S} particle size for purposes of this patent application and appended claims means that s percent by volume of the metal oxide particles have a particle diameter no greater than the D_{S} value. For the purposes of this definition, the particle size distribution (PSD) used to define the D_{S} value is measured using commonly used techniques, for example, centrifugal separation disc, laser scattering techniques using a Horiba LA1900, Microtrac Model S3500 particle size analyzer from Microtrac, Inc. (Clearwater, Fla.), or acoustic and electroacoustic method, for example, DT-1200 Acoustic and Electroacoustic Spectrometer from Dispersion Technology, Bedford Hills, N.Y., and ZetaPals from Brookhaven Instrument Inc., New York. The “median particle diameter” is the D₅₀ value for a specified plurality of metal oxide particles.

“Slurring agent” refers to a liquid or solvent or solution used to prepare a slurry from a power or a more concentrated slurry, a paste or semi-solid.

“Slurring aid” refers to a chemical or component added during the slurring process or post-slurry formation process to achieve more desired slurry features, i.e., desired viscosity, surface tension, or pH, or conductivity, or surface charge. Addition of surface tension reducer can result in appreciable reduction in slurry surface tension. An acidic slurring aid can lead to lower pH. A surface charge modifier can cause significant change in surface charge or change from positive to negative, or from zero charge to moderately or highly charged. An electrolyte added can result in a significant increase in slurry conductivity.

“Particle diameter” as used herein means the diameter of a specified spherical particle or the equivalent diameter of non-spherical particles as measured by laser scattering method using for example Microtrac Model S3500 particles size analyzer.

“Polishing medium” is defined herein as a combination of solid particles suspended in a liquid medium used in a polishing process where materials of a target surface are removed in a controllable manner to achieve ultimate evenness or surface perfection for a particular application. During the polishing process, polishing aids can be used to help to dislodge finer particles removed from the target surface or to prevent the removed fine particles from reattaching to the target surface. The polishing medium is a combination of solids particles and other additives. Additives include acids, bases to adjust medium pH, surface active reagents, electrolytes, soluble ionic polymers and non-ionic polymers.

“Polishing rate” is defined herein as the amount of materials removed or dislodged during each contact between the targeted surface and the polishing medium or per unit time. For example, if 0.01 micron thick of material of the targeted surface is removed in a single round of contact, the polishing rate of this polishing slurry is 0.01 micron per pass. If the pad is rotating at 50 RPM, then the polishing rate is at 0.5 microns/min. Polishing rate is affected by the size and shape of the polishing particles, hardness and chemical nature of the polishing particles, concentration of the polishing particles, presence of the polishing additives or aides, polishing pad, and contact angle between the targeted surface and the polishing pad, and rotation speed of the polishing pad, and the application rate of polishing medium. Larger polishing particles tend to give high polishing rate but result in poor surface uniformity. Higher pad rotation speeds result in fast polishing. A higher polishing medium concentration and higher application rate produce a higher rate of polishing. Presence of certain polishing additives or aides could lead to faster dislodge of the removed materials from the targeted surface. More detailed discussion concerning effect of polishing medium can be found in book by J. M. Steigerwald, S. P. Murarka, and R. J. Gutmann, “Chemical Mechanical Planarization of Microelectronic Materials”, Chapter 3, John Wiley & Sons, New York, 1997.

“Milling” refers to a process to achieve effective particle size reduction by providing vigorous mechanical agitation, collision among targeted particles, high shear stress at the surface of the targeted particles leading fracture, breakdown, weakening of the integrity of the targeted particles. One particular type of mill is called medium mill as it requires a milling medium to create turbulence in addition to the high agitation speed, vertices, high surface stress or shear. Known medium mills include Eiger mills from Eiger Machinery Inc, Grayslake, Ill., Netzsch mills from Netzsch Fine Particle Technology, Exton, Pa., Puhler mills from Puhler Machinery and Equipment Col, Guangzhou, Guangdong, China, etc.

“Milling aid” refers to a chemical or an additive whose introduction into the polishing suspension or slurry can result in improved performance of suspension or slurry in terms of polishing efficiency, surface planarization, stability of the suspension or slurry, consistency of the suspension or slurry, modification of surface characteristics, for example, surface charge or zeta potential. Milling aid is selected from the group of inorganic acids (i.e., nitric acid, hydrochloric acid), bases (i.e., sodium hydroxide, sodium carbonate, potassium hydroxide), dispersants, surfactants, water soluble polymers, electrolytes and polyelectrolytes. A detail list of different types of surface modifier or surfactants can be found in “Surfactants and Interfacial Phenomena”, Chapter 1, 3^{rd} Edition, by M. J. Rosen, John Wiley & Sons, Hoboken, N.J., 2004.

“Milling medium” refers to particles or balls charged into a mill to facilitate particle size reduction of other particles during processing of the targeted particles. Milling medium typically has the characteristics of (1) high density, (2) being inert or very low activity towards milling chamber or other vessel surfaces, (3) high hardness, (4) spherical, (5) high surface uniformity or smoothness. Zirconia, especially stabilized zirconia is widely used as milling medium.

“Hardness” unless otherwise stated, is referred to Mohs' scale that is used to characterize resistance to scratch of surface of a given materials by the ability of a harder to scratch a softer material. It was originally developed to compare hardness of naturally occurred minerals.

“Loss rate of milling medium” is defined at the amount of milling medium lost due to wearing and tearing during operation expressed as a percentage of the amount of milling medium charged into the mill per round of rotation. For example, for a milling medium charge of 1000 grams, a loss of 1 gram for a milling of 1 hour at mill rotation speed of 5000 RPM, the loss rate is: 1 g/1000 g*100/(1*60 min*5000 RPM)=1/1000*100/(60*5000)=3.333×10⁻⁷%/round. The lower the lost rate the less wearing and tearing is on the milling medium.

“Zeta potential” or surface charge of a particle surface acquired in a suspension or slurry is a measurement of double layer, also called Stem layer, potential. It is a property of surface as a result of (1) ionization of the surface species in a medium, (2) selective ion adsorption. Medium includes, water, polar solvent, for example, heteroatom containing compounds, oxygenates, amines, sulfides, non-polar solvent, for example, hydrocarbons. Ionics include, metal cations, K⁺, Ca²⁺, Fe²⁺, Fe³⁺, Al³⁺, cationic polymer, for example, aluminum 13-mer, Cat Floc 8108+, Superfloc C-277; inorganic anions, NO₃⁺, CO₃²⁺, SO₄²⁻, PO₄³⁻, HPO₄²⁻, Cl⁻, F⁻, ClO₄⁻, S²⁻, Mo₂O₇²⁻, SiO₄²⁻, organic anions, HCOO⁻, CH₃COO⁻, oxalic anion, citric anion, sulfonics, polyoxyethylenated fatty alcohol carboxylates, ligninsulfonates, petroleum sulfonates, N-Acyl-n-alkylataurates, sulfosuccinate esters, phosphoric and polyphosphoric acid esters, fluorinated anionics.

Zeta potential can be measured using well known techniques like electrokinetic method, acoustic and electro-acoustic method, and electrophoretic light scattering method. Widely used instruments include, Brookhaven Instruments' ZetaPals, Zeta Plus; Matec Instruments' ESA 8000, ESA 9800; Dispersion Technology's DT-1200; Malvern Instruments ZetaSizer and NanSizer; Beckman Coulter Instruments Delsa Zeta Potential Analyzer.

“Isoelectric point (IEP) or point of zero charge (PZC)” is a surface characteristic of charged particle in the presence of medium. In aqueous systems, the PZC or IEP is the pH where the surface charge is zero, or surface potential is zero, or electric mobility of the particle is zero. The PZC is the more fundamental double layer property, but cannot be determined experimentally (J-E. Otterstedt and D. A. Brandreth, “Small Particles Technology, Chapter 6, Plenum Press, New York, 1998). Instead, the IEP is used to study and characterize the stability, separation, recovery, or removal of small particles, for example, flocculation and aggregation behavior of colloidal systems. It can be determined by measuring the electric mobility as a function of pH when small monovalent cations are adsorbed on the particles. In addition to electrokinetics, acoustic and electro-acoustic spectroscopy methods, other methods, i.e., flocculation and settling measurement, adsorption measurements can also be used to determine IEP. General description and examples can be found in Chapter 3 of “Chemical Properties of Materials Surfaces”, by M. Kosmulski, Marcel Dekker, New York, 2001.

Generally speaking IEP of particles vary between 2 to 12. However, some particles do not have an IEP except at extreme acidic or basic conditions. Table 1 provides general zeta potential behavior of metal oxides. Alkali, and alkaline earth metal oxides tend to be positively charged at or near neutral pH whereas high multivalent metal oxides, dioxides and trioxides tend to be negatively charged at neutral pH.

It needs to be emphasized that surface charge or zeta potential of a particle is a surface characteristics. It is highly influenced by or dependent on the environment the particle is in, that is the medium, presence of ionics, and non-ionics, concentration of ionics and non-ionics. Due to this unique nature, zeta potential measurement and IEP determination is a highly sensitive measurement of presence of low levels of impurity, small perturbation of process conditions. As low as a few or a few tens ppm of impurity can lead to significant change in zeta potential. The consequences can be quite dramatic. For example, an otherwise stable system, can turn into formation of precipitation due to perturbation of process conditions leading to near IEP or passing IEP, that is charge reversal from positive to negative or the other way around. At IEP, due to lack of electrostatic repulsion, particles collide or attract to each other result in agglomerate, subsequently, leading to formation of large particles or flocs that settle or precipitate out under gravity.

Adsorption of anions deceases the IEP because more protons or acids are required to neutralize the negative charge of the anions adsorbed the surface. Furthermore, multivalent anions lower IEP much more than monovalent anion. Likewise, adsorption of cations increase the IEP. Adsorbed metal cations cause the IEP to shift toward the IEP of the hydrous oxide of the metal making up the cation.

### EXAMPLES

### Example-1

A slurry of alumina was prepared by mixing 48.6 kg of alumina and 32.4 kg of distilled water under constant mixing using a homogenizer at 500 RPM to give 81.0 kg of slurry with a solids content of 60 wt. %. The alumina used was obtained from Yuguang Specialty Ceramic Materials Ltd., Suzhou, Jiangsu, China. The pH of the slurry measured at 7° C. was at 10.6. This slurry was milled using an Eiger Mini Mill 250 and a milling medium, zirconia from Tosoh Corporation, Japan, at a loading of 872 g. Mill rotation (also called agitation) speed was controlled at 3600 RPM. The slurry was poured into the sample inlet funnel to maintain continuous flow out of the mill. Each pass meant that the entire slurry volume had gone through the mill once. Samples were collected at each pass for particle, pH, viscosity and surface charge characterization. This slurry was milled for 20 passes. At the end of milling, the milling medium was removed from the milling chamber and thoroughly cleaned and washed with distilled water and let dry at 110° C. to measure its weight. Weight loss of the medium was thus obtained based on the initial weight and after use. Loss rate can be calculated based on the method defined. The result is given in Table 1.

### Example-2

An amount of 20.75 kg of alumina slurry at 60 wt. % solids content was prepared according to Example-1. Its acidity was adjusted to give a pH of 4.3 using concentrated nitric acid (76 wt. %). This slurry was milled using the same mill and operation condition as Example-1. It was milled for a total of 16 passes. After milling the slurry pH increased to pH of 5. Loss rate of milling medium was determined according to the same protocol as Example-1. The results are given in Table 1.

### Example-3

An amount of 2.0 kg of alumina slurry at 60 wt. % solids content was prepared using an alpha-alumina from Panda Chemicals, Jinan, Shandong, China, according to Example-1. The slurry had a pH of 10.5 before milling. This slurry was milled using the same mill and operation condition as Example-1. It was milled for 50 passes. Loss rate of milling medium was determined according to the same protocol as Example-1. The results are given in Table 1.

### Example-4

Zeta potential of slurry sample was measured using a Brookhaven Instruments ZetaPals instrument. The instrument was first checked using a BI standard, BI-ZR3 for both zeta potential and particle size. This material is supposed to give a zeta potential of −49 mV±4 mV, and a particle size of 283 nm±5 nm. If the measurement results fall into the specified range of spread then the instrument is ready for taking measurement of samples. For any given slurry sample, it was first diluted using 1 mM potassium chloride solution to give a concentration between 0.02 mg/cc to 0.2 mg/cc. For IEP measurement, adjusting pH is carried out on a diluted sample using potassium hydroxide to increase pH or nitric acid to reduce pH. The zeta potential curve of sample prepared from Example-2 is shown in FIG. 1.

### Example-5

The zeta potential curve of sample prepared from Example-3 is shown in FIG. 2. Measurement protocol and instrument used is the same as that used in Example 4.

Example-2 shows that adjusting pH lower from 9.7 to 4.3 followed with milling had resulted in substantial reduction on wear loss rate of the medium, from 7.08×10⁻⁶%/R to 4.81×10⁻⁶%/R, a 32% reduction in medium wear loss.

Example-3 shows that a different alumina (Jiyuan) milled at pH=9.8 resulted in a medium loss rate of 2.20×10⁻⁵%/R, a three times increased compared to Example-1.

Without wish to bound by any given theory, it is believed that the hardness of given surface, particularly metal oxide surfaces or surfaces that have strong interaction with water or an aqueous solution, could vary substantially depending on its surface charge and extent of surface charge. It is further believed that materials at their surface IEP their hardness is at or near the maximum. Moving farther away from the IEP results in substantial surface charge, i.e., positive at pH below IEP and negative at pH above IEP, both lead to weakening (reduction in hardness) of the surface. It is further believed based on data presented in Table 2 that hardness of alumina varies substantially depending on its surface composition and IEP. A higher surface hydroxyl concentration leads to a lower IEP which corresponds to a lowered hardness.

To further illustrate this point, FIG. 3 gives the results for chemical and mechanical polishing of glass surface using an alumina polishing medium. The glass surface had an IEP of 2.9 and the alumina had an IEP of 9. It shows that at near the IEP point of glass, polishing rate is at the lowest because that glass surface is the strongest. Only at pH near the IEP point of the milling medium and further away from the IEP of the glass, the polishing rate is near maximum. Further move away from both IEP points of glass and alumina, it also leads to lowered polishing rate because medium surface is weakened.

We found that unexpectedly that not only does IEP of alumina vary but so does the hardness. The results are presented in Table 3. For aluminas with different surface composition, their hardness and IEP appear to correlate each, the lower the IEP the lower hardness. This provides a powerful tool to select starting target materials. The material to be selected should be the one with low IEP. Likewise, to select milling medium, materials whose surface having an IEP closer to its pristine IEP should be selected.

For Example-3, the high wear loss rate is due to in part of the high milling pH making milling operation far away from the IEP of the milling medium, and in part due to the appreciated increase in the IEP of the target material, i.e., IEP_{TM} of 7.3 (FIG. 2) vs. 6.7 (Example-1, FIG. 1). The higher IEP corresponds to a higher hardness. An significant increase in hardness of the target surface and the rather small difference between the milling medium and the target surface could result in a major increase in wear loss during milling.

Given the fact the milling is surface phenomenon, i.e., contact between surface of the milling medium and that of the target materials, it is critical to choose condition of milling and exact type of milling medium to maximize milling efficiency and minimize wear loss of milling medium. The selection guiding principle is illustrated in FIG. 4.

Table 4 presents IEP of a number of zirconia-based milling medium. It is clear, IEP of milling medium can vary quite substantially depending on the composition of the milling medium. To avoid potential conflict caused by similarity in IEP of milling medium and target surface, milling medium with the largest difference from that of the target surface should be selected if all possible. For yttrium modified zirconia materials, material with higher yttrium content should be considered.

To those skilled in the art, that a major reduction in wearing and tearing of milling medium can result in not only major cost saving associated with lowered medium loss rate but also lead to major reduction cross-contamination caused by introduction of debris generated from milling medium.

The present invention has demonstrated by modifying the surface charge or IEP of the target surface and operating at close to the IEP point of milling medium one can achieve substantially lowered loss rate of the milling medium during milling.

TABLE 1
Results of Examples 1-4: Wear Loss Rate of
Medium and Process Parameters

| | Medium | | | |
|---|---|---|---|---|
| | Loading | Mill Rotation | pH of Milled | Wear Loss Rate |
| Example | (g) | Rate (RPM) | Slurry | (wt %/R) |
| Example-1 | 872 | 3600 | 9.7 | 7.08E−06 |
| Example-2 | 872 | 3600 | 5.0 | 4.81E−06 |
| Example-3 | 872 | 3600 | 10.4 | 2.20E−05 |

TABLE 2
Properties of Aluminas: Isoelectric Point and Hardness

| | Hydroxyl Per | Hardness | |
|---|---|---|---|
| Material | Molecular Unit | (Moh's Scale) | IEP |
| α-Al₂O₃ | ~0 | 9 | 9 |
| γ-Al₂O₃ | >0 | 8 | 8 |
| AlO(OH) | 1 | 5 | 6.3 |
| Al(OH)₃ | 3 | 3 | 5.1 |

TABLE 3
IEP of Zirconia-Based Milling Medium

| ZrO₂ or Y₂O₃-Stabilized ZrO₂ | Y₂O₃ (mol. %) | IEP |
|---|---|---|
| ZrO₂ (Tosoh) | 0 | 7.2 |
| ZrO₂-8 mol. % Y₂O₃ (Tosoh) | 8 | 9.4 |
| ZrO₂-5 mol. % Y₂O₃ (Tosoh) | 5 | 7.1 |
| ZrO₂-3 mol. % Y₂O₃ (Tosoh) | 3 | 6.8 |
| ZrO₂ (hydrous) | 0 | 6.7 |

### FIGURE DESCRIPTION

FIG. 1: Zeta potential measurement results on milled alumina (HA) after 6 passes. Slurry concentration during milling is 60 wt. %. Measured using Brookhaven Instruments Inc. ZetaPals. This milled alumina (Al—HA) has an IEP=6.7.

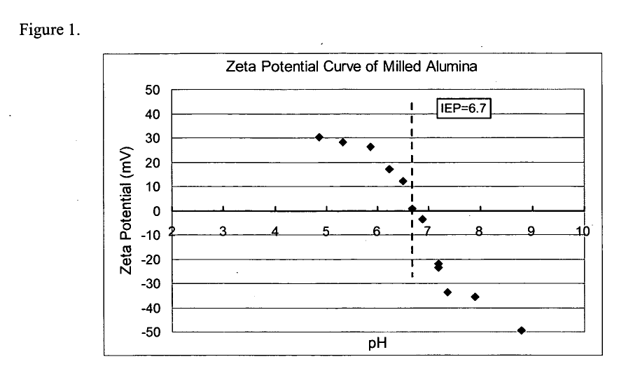

FIG. 2: Zeta potential measurement results on milled alumina (JY) after 50 passes. Slurry concentration during milling is 60 wt. %. Measured using Brookhaven Instruments Inc. ZetaPals. This milled alumina (Al-JY) has an IEP=7.3. It is appreciably higher than that of Al—HA of Example-1 (FIG. 1).

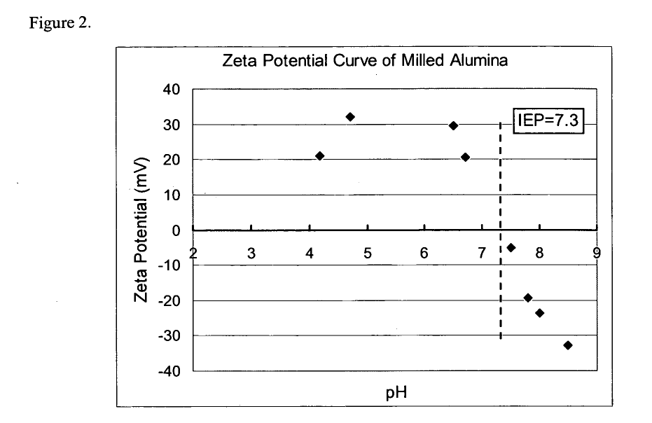

FIG. 3: Removal of material from glass surface during chemical and mechanical polishing: impact of pH on removal rate, and relationship to IEP of target surface and polishing medium. At or near the IEP of the target surface (the left end of the graph) or at or near the IEP of the polishing medium (the right end of the graph), removal rate is at the lowest, while far away from either IEPs, removal rate is at the highest (center region of the graph).

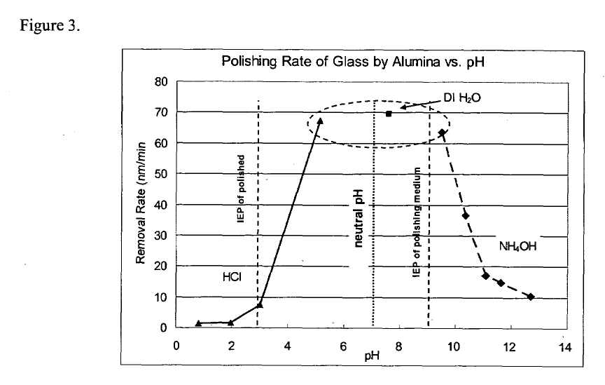

FIG. 4: Schematics showing regimes of milling operation to stay away from IEP of target surface: IEP_{TS}, and stay close to the IEP of milling medium: IEP_{MM}. Region-I and Region-III should be avoided because in Region I & Region III it is not close enough to the IEP_{MM}, wearing on milling medium is high; Region-II is the best compromise, because it is closer to the IEP_{MM} of the milling medium but significantly away from IEP_{TS} of target surface.

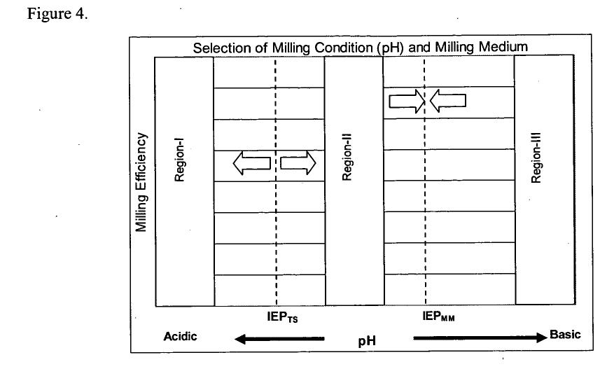

### REFERENCES

1. J-E. Otterstedt and D. A. Brandreth, “Small Particles Technology”, Plenum Press, New York, p.8, 1998.

2. R. L. Xu, “Particle Characterization: Light Scattering Method”, Kiuwer Academic Publisher, Dordrecht, The Netherlands, pp. 1-24, 2000.

3. P. A. Webb and C. Off, “Analytical Methods in Fine Particle Technology”, Micromeritics Instrument Corp., Norcross, pp. 17-28, GA.

4. A. M. Spasic and J-P. Hsu, “Finely Dispersed Particles: Micro-, Nano-, and Atto-Engineering”, Taylor & Francis, Roca Raton, pp. 329-340, 2006.

5. J. M. Steigerwald, S. P. Murarka, and R. J. Gutmann, “Chemical Mechanical Planarization of Microelectronic Materials”, John Wiley & Sons, New York, pp.1-47, 1997.

6. M. J. Rosen, “Surfactants and Interfacial Phenomena”, Chapter 1, 3^{rd} Edition, John Wiley & Sons, Hoboken, N.J., 2004.

7. M. Kosmuiski, “Chemical Properties of Materials Surfaces”, Chapter 3, Marcel Dëkker, New York, 2001.

8. T. C. Patton, “Paint Flow and Pigment Dispersion: A Rheological Approach to Coating and Ink Technology”, Chapter 1, pp. 1-13, p. 270, 2^{nd} Edition, John Wiley & Sons, New York, 1979.

We claim:

1. A process of particle size reduction comprising of:
(a) forming a slurry containing a metal oxide, a slurrying agent and optionally a slurring aid;
(b) milling the slurry to achieve particle size reduction;
(c) optionally using a milling medium during milling;

2. The process of claim 1, the wear loss rate of the milling medium is reduced:
(a) by at least 5%, more preferably by at least 7%, more preferably by at least 8%

3. A process to carry out particle size reduction of target particles wherein the:
(a) target particle containing slurry having an IEP_{TS};
(b) milling medium or rotor-stator material having an IEP_{MM};
(c) milling under conditions away from the IEP point of the target surface but near or close to the IEP point of the optional milling medium or milling rotor-stator

4. A composition of milling medium:
(a) wherein the milling medium is selected from the group of alumina, alumina-silica, calcium oxide, ceria, iron oxide, magnesia, manganese oxide, zirconia, yttria, copper oxide, mixed metal oxide, or any combination of thereof;
(b) the milling medium has an IEP that is at least 0.2 pH unit away from that of the target surface;
(c) operating pH is at least 3 pH unit closer to the IEP of the milling medium;
(d) operating pH is at least 0.2 pH unit away from the IEP of the target surface.

5. A process of milling a slurry using a milling medium:
(a) wherein the milling medium is selected from the group of alumina, alumina-silica, calcium oxide, ceria, iron oxide, magnesia, manganese oxide, zirconia, yttria, copper oxide, mixed metal oxide, or any combination of thereof;
(b) the milling medium has an IEP that is at least 0.2 pH unit away from that of the target surface;
(c) operating pH is at least 3 pH unit closer to the IEP of the milling medium;
(d) operating pH is at least 0.2 pH unit away from the IEP of the target surface.

6. A composition of slurry comprising of:
(a) a target particle
(b) a slurring agent
(c) optionally a slurring aid.

7. Composition of claim 6, wherein the target particle is selected from the group of metal oxide, clay, zeolite, both synthetic and natural, ceramic precursor, catalyst support, catalyst precursor or any combination of thereof.

8. Composition of claim 6, wherein the slurring agent is selected from the group of solvent both inorganic and organic, including, water, light alcohol, aqueous solution, a solution of polymer, acidified water, basic water, basic solution, acid solution, or any combination of thereof.

9. Composition of claim 6, wherein the slurring aid is selected from the group of surface modifying agents including surfactants, ionics, water soluble polymers, surface tension reducing chemicals or solvents, wetting agents, water soluble cationic polymers, water soluble anionic polymers, non-ionic water soluble polymers or any combination of thereof.

10. A process for using a slurry with reduced particle size as a polishing medium to achieve chemical and mechanical polishing of surfaces resulting in:
(a) smoothness or planarization of a target surface;
(b) size reduction of target object;
where the target is an article, a particle or a combination of thereof.

11. The process of claim 8, wherein the polishing rate is at most 1 microns per pass, more preferably at most 0.5 microns per pass, even more preferably at most 0.25 microns per pass.

12. A process for producing a slurry comprising of:
a plurality of metal oxide, clay, zeolite, molecular sieve, colloidal binder, surface modifier:
(a) wherein the oxide is selected from the group of alumina, alumina-silica, calcium oxide, ceria, iron oxide, magnesia, manganese oxide, zirconia, yttria, copper oxide, mixed metal oxide, or any combination of thereof;
(b) a milling medium is selected from the group of refractory materials including but not limited to alumina, silica, titania, ceria, zirconia, carbides, nitrides, mixed oxides or stabilized metal oxides or any combination of thereof.
